(19) United States
(12) Patent Application Publication
(10) Pub. No.: US 2010/0266732 A1
(43) Pub. Date: Oct. 21, 2010

(54) MICROWAVABLE SELF-VENTING PACKAGE

(75) Inventors: John S. Thomas, Coopersburg, PA (US); Jeffrey Scott Beer, Coopersburg, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: FRES-CO SYSTEM USA, INC., Telford, PA (US)

(21) Appl. No.: 12/426,447

(22) Filed: Apr. 20, 2009

(51) Int. Cl. B65D 81/34; H05B 6/80; B65D 33/01

(52) U.S. Cl. 426/113; 219/725; 383/103

(57) ABSTRACT

A flexible package for a product, e.g., a food product, to enable any steam resulting from heating the product in the package to automatically vent is disclosed. The package has a hollow interior space in which the product is located and is made up of a flexible sheet material. Portions of the flexible sheet material are sealed to each other along an elongated seal line, which forms a portion of the periphery of the hollow interior space. A portion of the seal line is in the form of a peelable interface. At least one vent is coupled to the peelable interface. The peelable interface automatically peels open upon the creation of steam within the package resulting from the heating of the product to allow the steam or other vapor to automatically exit through the at least one vent.

### BACKGROUND OF THE INVENTION

This invention relates to flexible packages and more particularly to packages suitable for heating products by microwaves and to enable vapor or steam to readily vent from the package.

It is a common practice in the packaging of foods for heating/cooking in a microwave oven to provide the package with a vent or some other mechanism or means to be opened to enable steam produced from the heating of the food within the package to vent. The prior art includes various United States patents and published applications relating to microwavable packages having some type of venting means, e.g., U.S. Pat. No. 4,261,504 (Cowan); U.S. Pat. No. 4,387,551 (Cowan); U.S. Pat. No. 4,404,241 (Mueller et al.); U.S. Pat. No. 4,419,373 (Opperman); U.S. Pat. No. 4,640,838 (Isakson et al.); U.S. Pat. No. 4,950,859 (Anderson); U.S. Pat. No. 5,195,829 (Watkins et al.); U.S. Pat. No. 5,434,393 (Jurkofsky); U.S. Pat. No. 5,464,969 (Miller); U.S. Pat. No. 5,780,824 (Matos); U.S. Pat. No. 5,928,553 (Toshima et al.); U.S. Pat. No. 6,380,524 (Keller); U.S. Pat. No. 6,607,764 (Keller); U.S. Pat. No. 6,818,873 (Savage); U.S. Pat. No. 7,034,268 (Hopkins); U.S. Pat. No. 7,172,780 (Skaife); U.S. Published Patent Application US20030152669 (Vadhar et al.); U.S. Published Patent Application US20050276885 (Bennett); U.S. Published Patent Application US20060269767 (Sankey et al.); U.S. Published Patent Application US20070215610 (Jau-Ming et al.); U.S. Published Patent Application US20080251518 (Tee);

While the aforementioned packages of the prior art may be generally suitable for their intended purposes to vent vapors/steam produced as the contents of the package are heated by microwave energy, they appear to suffer from one or more disadvantages, e.g., complexity of construction, difficulty to manufacture, inconsistent operation, inability to adequately dissipate steam, etc.

Thus, a need presently exists for a package which is simple in construction, can be made easily and inexpensively, and operates effectively to automatically vent vapor/steam therefrom.

### SUMMARY OF THE INVENTION

This invention is directed to a flexible package for a product to be heated within the package to enable any steam (or other vapors) resulting from the heating action on the product to automatically vent out of the package.

In accordance with one aspect of this invention the package comprises walls formed of a flexible sheet material defining a hollow interior space for receipt of the product therein. A first of the walls of the package is secured to a second of the walls of the package by an elongated seal. The seal forms at least a portion of the periphery of the hollow interior space. A first portion of the first of the walls of the package at the seal comprises a first inner surface area (e.g., a polyethylene layer). A second portion of the second of the walls of the package at the seal comprises second inner surface area (e.g., a polyethylene layer). At least one of the first and second inner surface areas has a patterned peelable coating (e.g., polyethylene EVA copolymer with talc) thereon. The first and second inner surface areas abut each other with the peelable coating interposed therebetween to form a peelable interface in one portion of the seal, with other portions of the seal being more resistant to peeling. The package also includes at least one vent coupled to the peelable interface. The peelable interface is arranged to automatically peel open upon the creation of steam within the package, whereupon the steam automatically exits from the hollow interior of the package through the peelable interface and the at least one vent.

In accordance with another aspect of this invention the package comprises at least two panels formed of a flexible sheet material defining a hollow interior space therebetween for receipt of the product, an elongated seal between portions of the panels and at least one vent. The elongated seal is of a predetermined thickness and has an inner edge defining a peripheral portion of the hollow interior of the package. A portion of the elongated seal includes a peelable interface having an inner edge flush with the inner edge of contiguous portions of the elongated seal. The peelable interface is of a smaller thickness than the predetermined thickness of contiguous portions of the elongated seal. The at least one vent is coupled to the peelable interface. The peelable interface is arranged to automatically peel open upon the creation of steam within the package, whereupon the steam automatically exits from the hollow interior of the package through the at least one vent.

In accordance with still another aspect of this invention the package comprises at least two panels formed of a flexible sheet material and defining a hollow interior space therebetween for receipt of the product, a plurality of vents and an elongated seal between portions of the panels. The elongated seal defines a portion of the periphery of the hollow interior space. Portions of the elongated seal form a peelable interface. The plurality of vents is coupled to the peelable interface. The peelable interface is arranged to automatically peel open upon the creation of steam within the package, whereupon the steam can automatically exit from the hollow interior of the package through the plurality of vents, thereby dispersing the steam.

The packages of this invention are particularly suitable for holding a food product hermetically sealed within the hollow interior of the package. A gas can be included in the package to enhance the shelf-life or sterility of the food product.

### DESCRIPTION OF THE DRAWING

FIG. 1 is a plan view of one exemplary flexible package or pouch having an automatically openable (e.g., peelable interface) constructed in accordance with an aspect of this invention;

FIG. 2 is an enlarged sectional view taken along line 2-2 of FIG. 1;

FIG. 3 is a plan view of the bottom portion of the package of FIG. 1 shown after its peelable interface has automatically opened as a result of steam being created in the package by the heating (e.g., microwaving) of the package's contents;

FIG. 4 is a plan view, similar to FIG. 1, but showing another exemplary flexible package constructed in accordance with another aspect of this invention;

FIG. 5 is a plan view of the top portion of the package of FIG. 4 shown after its peelable interface has automatically opened as a result of steam being created in the package by the heating of the package's contents;

FIG. 6 is a plan view, similar to FIGS. 1 and 4, but showing still another exemplary flexible package constructed in accordance with another aspect of this invention;

FIG. 7 is a plan view of the bottom portion of the package of FIG. 6 shown after its peelable interface has automatically opened as a result of steam being created in the package by the heating of the package's contents;

FIG. 8 is a plan view of the bottom portion of still another exemplary flexible package constructed in accordance with another aspect of this invention;

FIG. 9 is a plan view of the bottom portion of the package of FIG. 8 shown after its peelable interface has automatically opened as a result of steam being created in the package by the heating of the package's contents;

FIG. 10 is a plan view, similar to FIGS. 1, 4, and 6 but showing still another exemplary flexible package constructed in accordance with another aspect of this invention;

FIG. 11 is a plan view of the top portion of the package of FIG. 10 shown after its peelable interface has automatically opened as a result of steam being created in the package by the heating of the package's contents;

FIG. 12 is a plan view of the bottom portion of still another exemplary flexible package constructed in accordance with another aspect of this invention;

FIG. 13 is a plan view of the bottom portion of the package of FIG. 12 shown after its peelable interface has automatically opened as a result of steam being created in the package by the heating (e.g., microwaving) of the package's contents;

FIG. 14 is a plan view, similar to FIGS. 1, 4, 6 and 10 but showing still another exemplary flexible package constructed in accordance with another aspect of this invention; and

FIG. 15 is a plan view, similar to FIGS. 1, 4, 6, 10 and 14 but showing still another exemplary flexible package constructed in accordance with another aspect of this invention.

### DETAILED DESCRIPTION OF THE PREFERRED EMBODIMENT

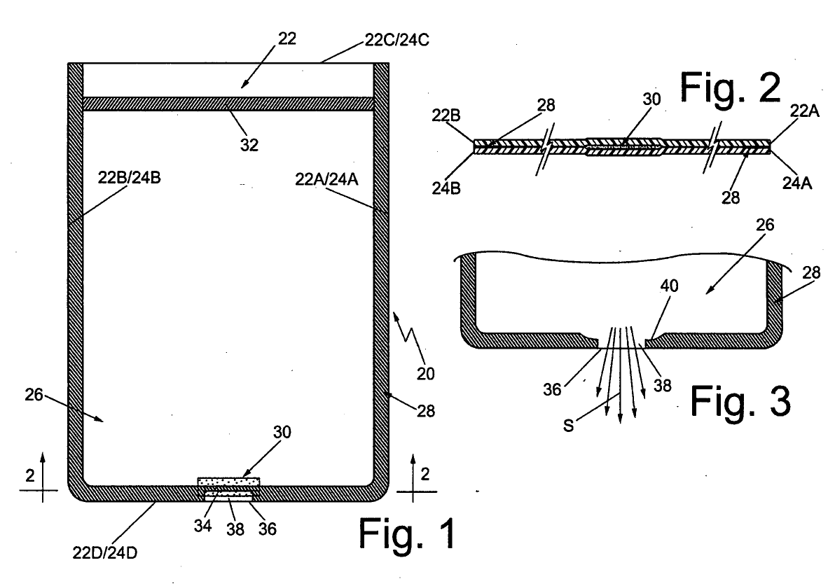

Referring now to the various figures of the drawing wherein like reference characters refer to like parts, there is shown at 20 in FIG. 1 one exemplary embodiment of a flexible package constructed in accordance with this invention. It should be pointed out at this juncture that this invention contemplates a variety of type of packages, e.g., “pillow” type pouches (rectangular or otherwise shaped), stand-up pouches (i.e., pouches having a bottom gusset to produce a self-standing geometry), “brick” shaped packages, etc. In any case, the packages of this invention are particularly suitable for holding solid foods that when heated in a microwave oven, produce steam without significant free liquid. Fresh vegetables are one such food that may be provided in the packages of this invention.

In the exemplary embodiments shown and described herein, each package is shown as being in the form of a pouch that basically comprises a pair of wall panels 22 and 24 (FIG. 2) formed of a flexible sheet material. That material can be either a single ply or multiple plies of any suitable conventional flexible packaging material. For example, the panels may be constructed to include a polyethylene or some other suitable material inner surface, thereby enabling confronting portions of the panels to be sealed (e.g., fused or welded) together. In the exemplary embodiments shown, the panels 22 and 24 are of the same size and shape and are disposed confronting each other to form a hollow interior space or chamber 26 in which the food product (not shown) to be packaged is disposed. In particular, the panel 22 is of generally rectangular shape (with somewhat rounded corners) having a pair of opposed linear side edges 22A and 22B, a top edge 22C and a bottom edge 22D, while the panel 24 is also of generally rectangular shape having a pair of opposed linear side edges 24A and 24B, a bottom edge 24C and a top edge 24D. The panels 22 and 24 are permanently secured together via a peripheral weld or seal line 28 extending along the edges 22A, 24A, 22B, 24B, 22C and 24C. Except for an automatically peelable interface portion (to be described later) of the seal line 28 that is located in the bottom of the package 20 for the embodiment 20, the seal line 28 is a permanent one, e.g., it constitutes a welded or fused joint that is resistant to being peeled or torn open. The permanent seal line 28 can be formed in various conventional ways, e.g., by use of heated bars, rollers, ultrasonic welding, etc.

The peripheral seal line 28 forms a portion of the periphery of the package's interior chamber 26. The remaining portion of the periphery of the package's hollow interior chamber is a transverse seal line that serves as the package's mouth, i.e., it is openable to provide access to the food within the interior chamber 26. In the exemplary embodiment shown in FIG. 1, the mouth of the package is sealed closed by use of a transversely oriented, peelable seal line 32. That seal line extends between the side 22A, 24A and the side 22B, 24B. The transverse seal line 32 is located a short distance below the top edge 22D, 24D of the package to provide respective portions of the panels 22 and 24 that can be grasped between the user's fingers to open the package's mouth, i.e., to pull the package apart at its top, to gain access to the package's contents. If desired the transverse seal line 32 may be permanent, so that opening of the package will have to be accomplished by cutting or otherwise removing a portion of the package just below the transverse seal line.

Since the packages of this invention are designed for heating (e.g., microwaving) of foodstuffs, each of those packages includes means to enable steam produced during such heating to be automatically vented therefrom to prevent or at least reduce the chance that the user will be burned (scalded) when he/she opens the package. That means basically comprises the heretofore mentioned peelable interface portion. Thus, with respect to the package 20, the peelable interface portion comprises portions of the respective inner surfaces of the flexible material panels 22 and 24 making up the package's peripheral seal line 28 and an interposed peelable coating 30 (FIGS. 1 and 2). In particular, the peelable interface is formed by applying the peelable coating 30, e.g., polyethylene EVA copolymer with talc, to the inner surface of either one or both of the panels 22 and 24. The peelable coating is preferably confined to an area or zone at the desired portion of the seal line 28 at which the steam is desired to vent. In the exemplary embodiment shown the peelable coating 30 is in the form of a rectangular patch located at approximately the center of the seal line 28 at the bottom of the package 20. For reasons that will be described shortly, the seal line 28 is notched or of a reduced thickness at the location of the peelable coating 30, i.e., the thickness of the seal line 28 in that area is smaller than the thickness of the remainder of the seal line. The notch is designated by the reference number 34. In the exemplary embodiment the elongated seal line 28 is of a predetermined constant thickness, e.g., nominally 10 mm, along its entire length except for the portion at the notch 34, where the thickness of the seal line is less, e.g., nominally approximately 5 mm.

The confronting portions of the panels 22 and 24 between the notch 34 and immediately adjacent peripheral edge 36 of the panels 22 and 24 forms a passageway or vent 38 through which steam can pass when the peelable interface opens. That action occurs as follows: the production of steam within the package 20 applies a force to the panels 22 and 24 tending to pull them apart. The permanent nature of the peripheral seal line 28 resists opening or peeling apart along its entire length, except for the region at which the peelable interface is located. At that region the abutting portions of the panels 22 and 24 tend to delaminate or peel apart due to the reduced peel strength of the interposed peelable coating 30. Moreover, the reduced thickness of the seal line 28 at that region (i.e., the portion of the seal line at the notch) provides less resistance to peeling apart than the thicker contiguous portions of the seal line 28. As shown in FIG. 3, this action forms a gap or breach 40 in the seal line 28, through which steam S can pass to the contiguous vent 38 to exit out of the package as shown by the arrows in that figure.

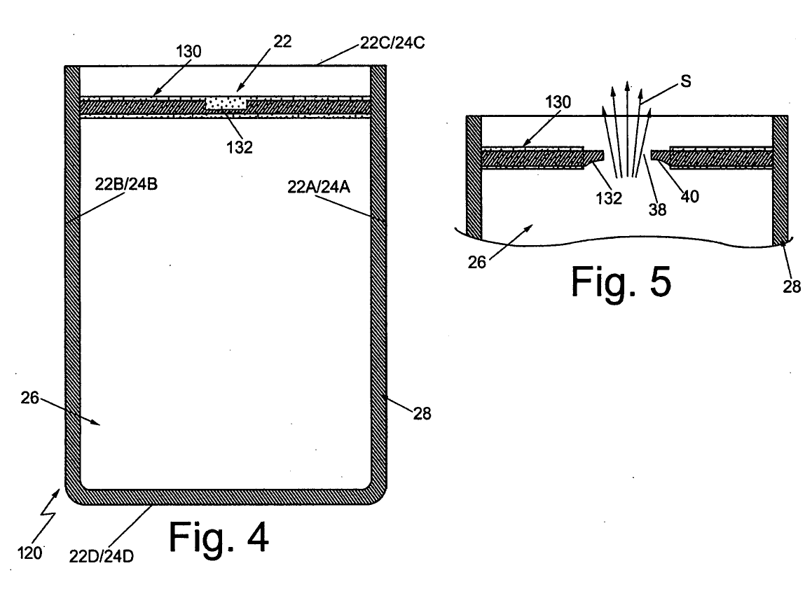

In FIGS. 4 and 5 there is shown another exemplary flexible package or pouch 120 that is constructed in accordance this invention. The package 120 is similar in construction to the package 20, except that the peelable interface for automatically venting steam from the package 120 is located within a transverse seal 132 forming the package's mouth, instead of being located in the bottom portion of the peripheral seal line 28. In the interest of brevity all of the details of the construction and operation of the package 120 will not be reiterated herein and those features/components of package 120 that are common to the package 20 will be given the same reference numbers. Thus, the package 120 includes a pair of wall panels 22 and 24 (only panel 22 can be seen) formed of a flexible sheet material, like package 20, and which are secured together along a peripheral permanent weld or seal line 28. The seal line 28 forms a portion of the periphery of the package's chamber 26. The mouth of the package's chamber 26 is sealed closed by the heretofore identified transverse seal line 132 which extends between the side 22A, 24A and the side 22B, 24B. The peelable interface of the package 120 comprises portions of the respective inner surfaces of the flexible material panels 22 and 24 making up the package's transverse seal line 132 and an interposed peelable coating 130. To that end, the peelable interface is formed by applying the peelable coating, e.g., polyethylene EVA copolymer with talc, in a strip to the inner surface of either one or both of the panels 22 and 24. The strip of coating extends along the full width of the transverse seal line 132. The seal line 132 includes a notch 134 of a reduced thickness at the location of the peelable coating 30, i.e., the thickness of the seal line 132 in that area is smaller than the thickness of the remainder of the seal line 132, for the same basic reason as given with respect to the notch 36 in the seal line 28 of the package 20, i.e., to facilitate the formation of a gap 40 in the seal line through which steam S can pass when the peelable interface opens. This venting action is shown by the arrows in FIG. 5. Moreover, since the peelable coating 130 extends the full width of the transverse seal line 132, the entire seal line 132 can be peeled apart by the user of the package after the steam has vented to provide access to the contents of the package (i.e., the foodstuff within the chamber 26).

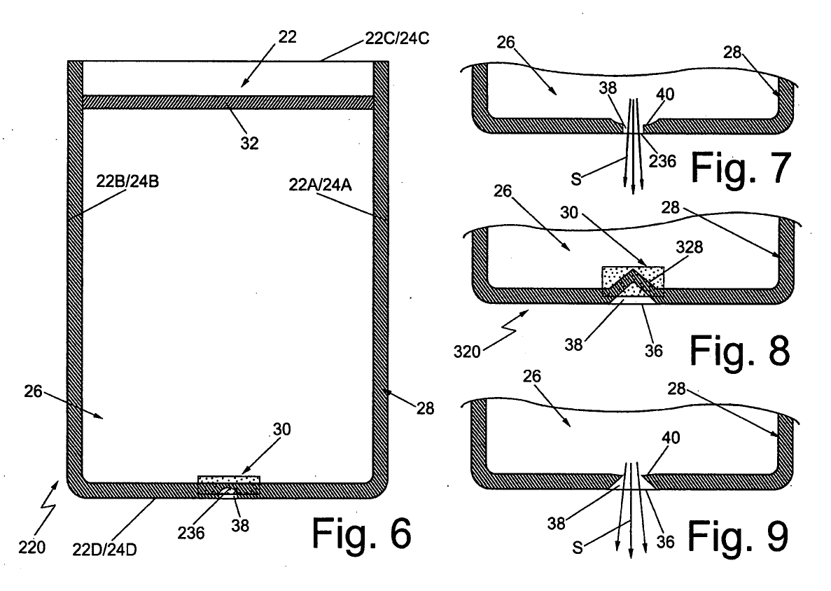

In FIGS. 6 and 7 there is shown another exemplary flexible package or pouch 220 that is constructed in accordance this invention. The pouch 220 is similar in construction to the package or pouch 20, except for the shape of the notch forming the vent at the package's peelable interface. In the interest of brevity all of the details of the construction and operation of the package 220 will not be reiterated herein and those features/components of package 20 that are common to the package 20 will be given the same reference numbers. Thus, as can be seen in FIG. 6, the permanent seal line 28 includes a semicircular notch 236 at the location of the peelable coating 30. The notch 236 serves the same basic purpose as the notch 36 in the seal line 28 of the package 20, i.e., to form a passageway or vent 38 through which steam can pass when the peelable interface opens (as shown by the arrows in FIG. 7).

In FIGS. 8 and 9 there is shown the bottom portion of another exemplary flexible package or pouch 320 that is constructed in accordance this invention. The package 320 is similar in construction to the packages 20 and 220, except for the shape of the peripheral seal at the bottom of the package and the corresponding notch forming the vent at the package's peelable interface. In the interest of brevity all of the details of the construction and operation of the package 320 will not be reiterated herein and those features/components of package 320 that are common to the packages 20 and 220 will be given the same reference numbers. Thus, as can be seen in FIG. 8, the permanent seal line 28 includes a generally inverted V-shaped central portion 328. The thickness of each of the legs that make up the inverted V-shaped central portion is slightly less than the thickness of the contiguous portions of the permanent seal 28, although the legs could be the same thickness, if desired. The peelable interface portion of the package 320 comprises portions of the respective inner surfaces of the flexible material panels 22 and 24 making up the package's peripheral seal line 28 at the inverted V-shaped central portion 328 and an interposed peelable coating 30. The coating 30 is in the form of a rectangular patch. The confronting inner surfaces of the panels 22 and 24 located between the inverted V-shaped central portion 328 of the permanent seal line 28 and the marginal edge 36 of those panels forms a passageway or vent 38 through which steam can pass when the peelable interface opens. In particular, the permanent nature of the seal line 28 resists opening or peeling apart, except for the peelable interface 30. At that region the abutting portions of the panels 22 and 24 tend to delaminate or peel apart as shown in FIG. 9 due to the reduced peel strength of the interposed peelable coating 30. Moreover, the tapered tip of the inverted V-shaped central portion 128 which extends inward into the chamber 26 of the package provides less resistance to the remainder of the seal line peeling open. Accordingly, the portions of the panels 22 and 24 at the tip of the inverted V-shaped portion 128 delaminate from each other first and then that delamination action proceeds or propagates across the entire inverted V-shaped portion within the bounds of the peelable coating patch 30. This process forms a gap or breach 40 in the seal line 28, through which steam S can pass to the contiguous vent 38 to exit out of the package as shown by the arrows in FIG. 9.

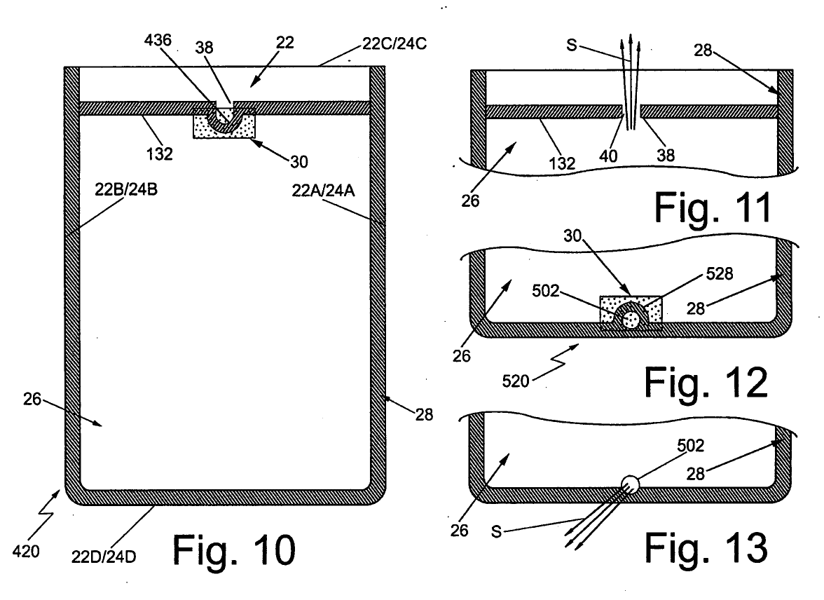

In FIGS. 10 and 11 there is shown another exemplary flexible package or pouch 420 that is constructed in accordance this invention. The pouch 420 is similar in construction to the package or pouch 120, except that the transverse seal 132 forming the mouth of the package includes a differently shaped portion 436 at which the peelable interface is located. In the interest of brevity all of the details of the construction and operation of the package 420 will not be reiterated herein and those features/components of package 420 that are common to the package 120 will be given the same reference numbers. Thus, as can be seen in FIG. 10, the package 120 includes a pair of wall panels 22 and 24 formed of a flexible sheet material which are secured together along a peripheral weld or seal line 28. The seal line 28 forms a portion of the periphery of the package's interior chamber 26. The mouth of the package's interior chamber 26 is sealed closed by transverse seal line 132. That seal line includes a generally U-shaped portion 436 whose apex is directed into the interior chamber of the package. The peelable interface 30 of the package 420 comprises portions of the respective inner surfaces of the flexible material panels 22 and 24 making up the package's transverse seal line 132 and an interposed peelable coating 30 confined to the region of the U-shaped portion 436. In particular, the peelable coating is in the form of a rectangular patch located in the center region of the transverse seal line 132. The confronting inner surfaces of the panels 22 and 24 located between the legs of the U-shaped portion 436 of the seal line 132 forms a passageway or vent 38 through which steam can pass when the peelable interface opens. In particular, when pressure builds up within the package due to the formation of steam therein, the abutting portions of the panels 22 and 24 tend to delaminate or peel due to the reduced peel strength of the interposed peelable coating 130. Moreover, the rounded end of the U-shaped portion 436 which is directed into the chamber 26 provides less resistance to the seal line peeling 132 open thereat than at other portions of the seal line 132. Accordingly, the portions of the panels 22 and 24 at the inner end of the U-shaped portion 436 delaminate from each other first and then that delamination action proceeds or propagates across the entire U-shaped portion. This process forms a gap or breach 40 in the seal line 132, through which steam S can pass to the contiguous vent 38 to exit out of the package as shown by the arrows in FIG. 11.

In FIGS. 12 and 13 there is shown the bottom portion of another exemplary flexible package or pouch 520 that is constructed in accordance this invention. The package 520 is similar in construction to the package 320, except for the shape of the peripheral seal at the bottom of the package and the use of a hole to form the vent at the package's peelable interface. In the interest of brevity all of the details of the construction and operation of the package 520 will not be reiterated herein and those features/components of package 520 that are common to the package 320 will be given the same reference numbers. Thus, as can be seen in FIG. 12, the permanent seal line 28 at the bottom of the package includes a semicircular arch 528 portion extending into the chamber 26. A hole 502 extends through the panel 22 and is in communication with the hollow interior of the arch portion 528. If desired, a similarly shaped and located hole (not shown) can be provided extending through the panel 24. The peelable interface portion of the package 520 comprises portions of the respective inner surfaces of the flexible material panels 22 and 24 making up the package's peripheral seal line 28 at the semi-circular arch portion 528 and an interposed peelable coating 30. The coating 30 is in the form of a rectangular patch having a central hole coincident with the hole 502 in the panel 22. The hole(s) 502 form(s) a passageway or vent through which steam can pass when the peelable interface opens. In particular, the permanent nature of the seal line 28 resists opening or peeling apart, except for the peelable interface 30. At that region the abutting portions of the panels 22 and 24 tend to delaminate or peel apart at the semi-circular arch 528 due to the reduced peel strength of the interposed peelable coating 30. Since the innermost end of the arch 528 is smaller than the portions of the seal line 28 contiguous therewith, the delamination of the portions of the panels 22 and 24 from the innermost end propagates across the entire arch portion. This process forms a gap or breach 40 in the seal line 28, through which steam S can pass to the contiguous hole(s) 502 to exit out of the package as shown by the arrows in FIG. 13.

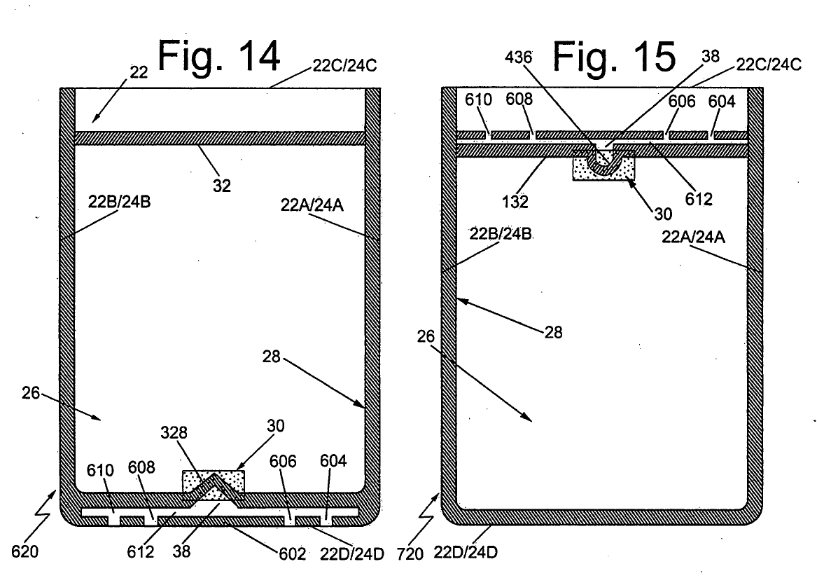

In FIG. 14 there is shown another exemplary flexible package or pouch 620 constructed in accordance this invention. The package 620 is similar in construction to the package 320, except that it includes a plurality of vents coupled to the peelable interface for dissipating the steam that exits from that interface. In the interest of brevity all of the details of the construction and operation of the package 620 will not be reiterated herein and those features/components of package 620 that are common to the package 320 will be given the same reference numbers. Thus, as can be seen in FIG. 14, a portion 602 of the permanent seal line 28 at the bottom edges 22D and 24D of the panels 22 and 24, respectively, includes a plurality of unsealed areas 604, 606, 608 and 610. In particular, the inner surfaces of the panels 22 and 24 at those areas confront each other, but are not sealed to each other, so that they form respective passageways between the confronting surfaces. The passageways 604, 606, 608 and 610 form the vents of the package 620 and are in communication to the package's peelable interface via a manifold channel 612. To that end the manifold channel comprises an unsealed transversely extending strip or region between the panels 22 and 24 immediately above the portion of the seal line 28 at which the vents 604, 606, 608 and 610 are located. The manifold channel 612 is in fluid communication with the vent 38 at the outlet of the package's peelable interface.

As should be appreciated by those skilled in the art, when the package's contents are heated, the steam produced within the package 620 causes its peelable interface (i.e., the inverted V-shaped portion 328 and the interposed peelable coating 30) to peel open in the same manner as described above with respect to the package 320. Accordingly, steam exits through the now opened interface and its associated vent 38. Instead of venting directly to the ambient surroundings (as is the case with the package 320), the steam passes into the manifold passageway 612, from whence it passes through the plural vents 604, 606, 608 and 610. This has the effect of dissipating the exiting steam across a considerably larger area, thus reducing the potential for the user to be scalded by the steam.

In FIG. 15 there is shown another exemplary flexible package or pouch 720 that is constructed in accordance this invention. The pouch 720 is similar in construction to the package or pouch 420, except that it includes a plurality of vents coupled to the peelable interface for dissipating the steam that exits from that interface. In the interest of brevity all of the details of the construction and operation of the package 720 will not be reiterated herein and those features/components of package 720 that are common to the package 420 will be given the same reference numbers. Thus, as can be seen in FIG. 15, a portion of transversely extending seal line 132 adjacent the top edges 22C and 24C of the panels 22 and 24, respectively, includes a plurality of unsealed areas 604, 606, 608 and 610. In particular, the inner surfaces of the panels 22 and 24 at those areas confront each other, but are not sealed to each other, so that they form respective passageways between the confronting surfaces. These passageways form the vents of the package 720 and are in communication with the peelable interface via a manifold channel 612. The manifold channel comprises an unsealed strip or region between the panels 22 and 24 immediately above the portion of the transverse seal line 132 at which the vents 604, 606, 608 and 610 are located. The manifold channel 612 is in fluid communication with the vent 38 at the outlet of the peelable interface.

As should be appreciated by those skilled in the art, when the package's contents are heated, the steam produced within the package 720 causes its peelable interface (i.e., the inverted U-shaped portion 436 and the interposed peelable coating 30) to peel open in the same manner as described above with respect to the package 420. Accordingly, steam exits through the now opened interface and its associated vent 38. Instead of venting directly to the ambient surroundings (as is the case with the package 420), the steam passes into the manifold passageway 612, from whence it passes through the plural vents 604, 606, 608 and 610. This has the effect of dissipating the exiting steam across a considerably larger area, thus reducing the potential for the user to be scalded by the steam produced.

It should be noted that the peelable coating(s) to form the peelable interfaces of this invention, can be applied in different manners than the manners described above. Thus, for example, the peelable coating may be shaped to conform to the precise shape of the portion of the seal line at which the coating is located instead of being in the form of an oversized patch or line. In fact, for some applications the entire inner surface of one or both of the panels making up the package may bear a peelable coating thereon. In such a case the seal line will be shaped, e.g., tapered, notched, or made in some other shape, to encourage the peeling action to commence at that shaped region of the seal line. Moreover, the peelable coating need not be a coating at all, but may be in the form of a sheet of material which is interposed and bonded between the interface of the inner surfaces making up the package's panels to forms a peelable interface. In such a case that peelable layer or sheet enables the confronting portions of the package's panels to delaminate from each other to peel open in that region.

Without further elaboration the foregoing will so fully illustrate our invention that others may, by applying current or future knowledge, adopt the same for use under various conditions of service.

We claim:

1. A flexible package for a product to be heated within the package while enabling any steam resulting from the heating action on the product to automatically vent out of said package, said package comprising walls formed of a flexible sheet material defining a hollow interior space for receipt of the product therein, a first of said walls being secured to a second of said walls by an elongated seal, said seal forming at least a portion of the periphery of said hollow interior space, a first portion of said first of said walls at said seal comprising a first inner surface area, a second portion of said second of said walls at said seal comprising a second inner surface area, at least one of said first and second inner surface areas having a patterned peelable coating thereon, said first and second inner surface areas abutting each other with said peelable coating interposed therebetween to form a peelable interface in one portion of said seal, with other portions of said seal being resistant to peeling, said package including at least one vent coupled to said peelable interface, said peelable interface being arranged to automatically peel open upon the creation of steam within the package, whereupon the steam automatically exits from said hollow interior of said package through said peelable interface and said at least one vent.

2. The flexible package of claim 1 wherein said peelable interface of said seal comprises a tapering portion projecting into said hollow interior of said package.

3. The flexible package of claim 2 wherein said tapering portion is arcuate.

4. The flexible package of claim 1 wherein said seal is of a predetermined width and has an inner edge, said inner edge defining a peripheral portion of said hollow interior of said package, said peelable interface having an inner edge flush with said inner edge of contiguous portions of said seal and being of a narrower width than the predetermined width of contiguous portions of said seal.

5. The flexible package of claim 1 wherein said vent comprises an interfacial space between portions of walls of said package contiguous with said peelable interface.

6. The flexible package of claim 1 wherein said vent comprises an opening in a portion of one of said walls of said package contiguous with said peelable interface.

7. The flexible package of claim 1 wherein said package additionally comprises a food product located within said hollow interior of said package, said package being hermetically sealed.

8. The flexible package of claim 7 wherein said package includes gas within said hollow interior of said package to enhance the shelf-life or sterility of said food product.

9. The flexible package of claim 1 wherein said at least one vent comprises a plurality of vents spaced apart from each other along a portion of said seal, each of said vents being arranged to enable a portion of the steam from the interior of said package to pass therethrough, thereby dispersing the steam.

10. The flexible package of claim 1 wherein said first and second inner surface areas comprise polyethylene and wherein said peelable coating comprises polyethylene EVA copolymer with talc.

11. A flexible package for a product to be heated within the package and to enable any steam resulting from the heating action on the product to automatically vent out of the package, said package comprising at least two panels formed of a flexible sheet material defining a hollow interior space therebetween for receipt of the product, an elongated seal between portions of said panels and at least one vent, said elongated seal being of a predetermined thickness and having an inner edge defining a peripheral portion of said hollow interior of said package, a portion of said elongated seal including a peelable interface having an inner edge flush with said inner edge of contiguous portions of said elongated seal, said peelable interface being of a smaller thickness than the predetermined thickness of contiguous portions of said elongated seal, said at least one vent being coupled to said peelable interface, said peelable interface being arranged to automatically peel open upon the creation of steam within said package, whereupon the steam automatically exits from said hollow interior of said package through said at least one vent.

12. The flexible package of claim 11 wherein said entire elongated seal is peelable and wherein said peelable interface is adapted to open before other portions of said elongated seal upon the creation of steam within the package.

13. The flexible package of claim 11 wherein said at least one vent comprises an interfacial space between said portions of said panels contiguous with said peelable interface.

14. The flexible package of claim 11 wherein said at least one vent comprises an opening in a portion of one of said walls of said package contiguous with said peelable interface.

15. The flexible package of claim 11 wherein said at least one vent comprises a plurality of vents spaced apart from each other along a portion of said elongated seal, each of said vents being arranged to enable a portion of the steam from the interior of said package to pass therethrough, thereby dispersing the steam.

16. The flexible package of claim 11 wherein said flexible sheet material comprises polyethylene and wherein said peelable interface comprises polyethylene EVA copolymer with talc.

17. A flexible package for a product to be heated within the package and to enable any steam resulting from the heating action on the product to automatically vent out of said package, said package comprising at least two panels formed of a flexible sheet material and defining a hollow interior space therebetween for receipt of the product, said package comprising a plurality of vents and an elongated seal between portions of said panels, said elongated seal defining a portion of the periphery of said hollow interior space, portions of said elongated seal comprising a peelable interface, said plurality of vents being coupled to said peelable interface, said peelable interface being arranged to automatically peel open upon the creation of steam within said package, whereupon the steam can automatically exit from said hollow interior of said package through said plurality of vents, thereby dispersing the steam.

18. The flexible package of claim 17 wherein said elongated seal comprises an inner edge contiguous with said hollow interior of said package and wherein said peelable interface comprises a projection, said projection projecting further into said hollow interior of said package than said inner edge of said contiguous portions of said elongated seal.

19. The flexible package of claim 18 wherein each of said projection includes a inner end and wherein said projection flares outward from said inner end to said inner edge of said contiguous portions of said elongated seal.

20. The flexible package of claim 17 wherein said plurality of vents comprises respective interfacial spaces between portions of said panels contiguous with said peelable interface.

21. The flexible package of claim 17 wherein said plurality of vents comprises plural apertures in at least one of said panels contiguous with said peelable interface.

22. The flexible package of claim 17 wherein said package additionally comprises a food product located within said hollow interior of said package, said package being hermetically sealed.

23. The flexible package of claim 17 wherein said flexible sheet material comprises polyethylene and wherein said peelable interface comprises polyethylene EVA copolymer with talc.
